(19) United States
(12) Patent Application Publication
(10) Pub. No.: US 2004/0122850 A1
(43) Pub. Date: Jun. 24, 2004

(54) System and method to award a prize to a winner of a competition

(76) Inventors: Richard A. Humphrey, Ellis County, TX (US); Mickey J. Humphrey, Dallas County, TX (US)

Correspondence Address: ROBINSON & POST, L.L.P., N. Texas Bank Tower, Ste. 575, 12900 Preston Road, LB-29, Dallas, TX, 75230-1329, US

(21) Appl. No.: 10/328,602

(22) Filed: Dec. 24, 2002

(51) Int. Cl. G06F 17/00

(52) U.S. Cl. 707/102

(57) ABSTRACT

A system and method to award a prize to a winner of a competition that embodies a plurality of registration centers for registering individuals engaging in the competition. A service center groups the registrants in predetermined segments and determines a winner of a prize in each of the predetermined segments. Apparatus transports the registrants identity from the registration centers to the service center and the identification of the award from the service center to the registration centers.

### BACKGROUND OF THE INVENTION

This invention relates to a system for and method of awarding a prize to a winner of a competition and, more specifically, to a system for and method of awarding a prize to a winner of a bowling competition.

Bowling is a ancient sport and through the years has become a popular activity for many individuals. For many years, individual bowlers have engaged in bowling centers and tournaments at local bowling centers.

Over the past few years, it appears that fewer individual bowlers are bowling in leagues and the popularity of the sport appears to be diminishing.

Accordingly, it is an object of the present invention to provide a system to award and a method for awarding a prize to a winner of a bowling competition that includes selected regions engaging in the competition.

### BRIEF SUMMARY OF THE INVENTION

In accordance with the present invention, there is provided a system to award a prize to a winner of a competition. The system comprises a plurality of registration centers for registering individuals engaging in the competition. A service center that groups registrants in predetermined segments and identifies a winner of a prize in each predetermined segment. Apparatus transports the registrant's identity from the registration centers to the service center and the identification of the award from the service center to the registration centers.

Further, in accordance with the present invention, there is provided a method of awarding a prize to a winner of a competition. The method comprises the steps of registering individuals engaging in the competition at a plurality of registration centers. Transporting the registrants' identity from the registration centers to the service center. The registrants are then grouped in predetermined segments. The score of the individual registrants is then transported to the service center. A winner of a prize in each predetermined segment is then determined by comparing the scores of the registrants. The identification of the award is then transported from the service center to the registration centers.

### BRIEF DESCRIPTION OF THE DRAWING

Objects and advantages of the invention will become apparent upon reading the following detailed description and upon reference to the drawings, wherein like reference characters are used throughout to designate like parts:

FIG. 1 illustrates a first embodiment of a system for awarding a prize to a winner of a competition constructed according to the present invention; and

FIG. 2 illustrates a second embodiment of a system for awarding a prize to a winner of a competition constructed according to the present invention.

### DETAILED DESCRIPTION OF THE INVENTION

Turning now to the drawings, there is shown a system 10 for awarding a prize to a winner of a competition constructed according to the present invention. System 10 includes plurality of registration centers for registering individuals engaging in the competition.

Preferably, the competition or sporting event is bowling and the plurality of registration centers includes a registration center 12 disposed in a bowling center 14, a registration center 16 disposed in a bowling center 18, a registration center 20 disposed in a bowling center 22, a registration center 24 disposed in a bowling center 26, a registration center 28 disposed in a bowling center 30, and a registration center 32 disposed in a bowling center 34.

As contemplated, each registration center is a kiosk having a conventional computer 36, preferably a personnel computer, supported in the kiosk. A conventional printer is connected to each computer 36 to print information inputted by the individual or registrant. A conventional bill validator is connected to each computer 36 for validating deposits of money made by the registrant at the registration center. A conventional credit card acceptor is connected to each computer 36 for validating charges made at the registration center. A conventional display is used with each computer 36 to provide instructions to a user on how to register, on payment and identification of the individual or registrant. A conventional printer is used with computer 36. A modem is used with each computer 36 to connect the respective registration center via an internet connection 38 to a processing or service center 40. The information provided by the individual or registrant to computer 36 is then forwarded via the internet from computer 36 to a processing computer 42 located in service center 40. To prevent outsiders from manipulating or interfering with the data being provided from computers 36, a security device 44 is used. After passing through a security device 44, the data is forwarded via line 46 to processing computer 42. A back-up or redundant processing arrangement is used that has a second processing computer 48 connected to security apparatus 44 via line 50. The same information sent from computers 36 is forwarded to processing computer 48 and becomes the primary processor when needed. Security device 44 may be either hardware or software.

Processing computers 42 and 48 are programmed to group the registrants in predetermined segments. The segments may arranged according to the geographic location or according to a business arrangement. For example, all of the bowling centers located in Dallas, Tex. may in a geographic segment, all of the Carter Bowling centers may be a business arrangement segment, or a particular sponsor of the sporting event, as with golf events, may be in a sport sponsored segment. Further, the prize may be for the highest total score, for the score in a selected frame, or in any other manner to be determined by the sponsor of the event.

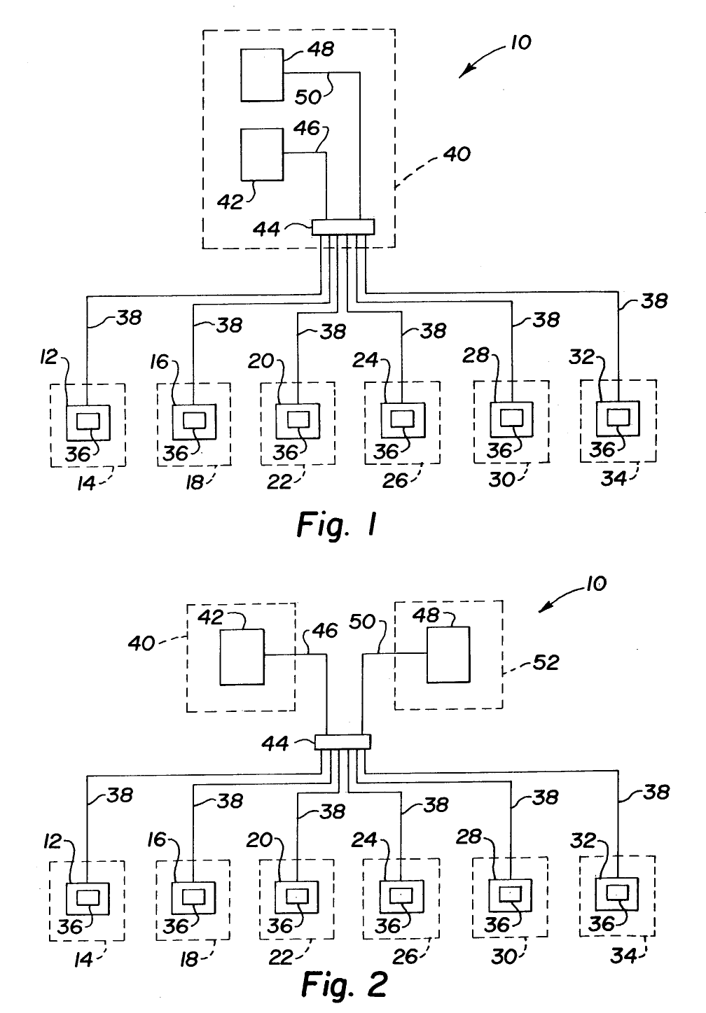

As shown in FIG. 1, the first embodiment has security device 44 disposed within center 40 to prevent an outsider from tampering with it.

As shown in FIG. 2, the second embodiment has security device 44 disposed away from center 40 and second processing computer 48 is disposed within a second processing center 52. The second processing center 52 is disposed sufficiently away from first processing center 40 so as to be on a different power grid and inhibit the likelihood of interruption of power to the back-up arrangement.

To award a prize to a winner of a competition, a number of individuals engaging in the competition register at different registration centers. The registrant's identity is then transported from registration centers 12, 16, 20, 24, 28 and 32 to service center 42. The registrants are then grouped in predetermined segments by service center 42. After the game, the score of the individual registrants are transported from centers 12, 16, 20, 24, 28 and 32 to service center 42. A winner of a prize in a predetermined segment is then determined. The identification of the award is then transported from service center 42 to each registration center 12, 16, 20, 24, 28 and 32.

Although a registration center is shown in each bowling center, there may be multiple registration centers in each bowling center when required or when desired.

Even though six bowling centers are shown, there may be more or less bowling centers in each predetermined region.

The invention having been described, what is claimed is:

1. A system to award a prize to a winner of a competition, comprising: a plurality of registration centers for registering individuals engaging in the competition; a service center for grouping registrants in predetermined segments and identifying a winner of a prize in each predetermined segment; and an apparatus for transporting each registrant's identity from said registration centers to said service center and the identification of the award from said service center to said registration centers.

2. The system set forth in claim 1, further comprising: the predetermined segments being determined by a sponsor of a sporting event.

3. The system set forth in claim 1, further comprising: at least one of said registration centers being disposed in a bowling center.

4. The system set forth in claim 1, further comprising: the predetermined segments being determined by a geographic area.

5. The system set forth in claim 1, further comprising: said registration centers including a computer for receiving information inputted by the registrant and a display for displaying information received from said service center connected to the computer.

6. The system set forth in claim 5, further comprising: said registration centers further including a printer for printing information connected to the computer.

7. The system set forth in claim 5, further comprising: said registration centers further including a bill validator for validating deposits of money made at the registration center connected to the computer.

8. The system set forth in claim 5, further comprising: said registration centers further including a credit card acceptor for validating charges made at the registration center connected to the computer.

9. The system set forth in claim 1, further comprising: said service center including a computer for receiving information from each registration center, determining the prize to be awarded in each predetermined segment and forwarding information about the prize to those registration centers located in the predetermined segment.

10. The system set forth in claim 9, further comprising: said service center including a back-up computer for receiving the information from each registration center, determining the prize to be awarded in each predetermined segment and forwarding information about the prize to those registration centers located in the predetermined segment.

11. A method of awarding a prize to a winner of a competition, comprising the steps of: registering individuals engaging in the competition at a plurality of registration centers; transporting the registrants identity from the registration centers to the service center; grouping the registrants grouped in predetermined segments; transporting scores of the individual registrants to the service center; comparing the scores of the registrants to determine a winner of a prize in each predetermined segment; and transporting the identity of the winner and the award to the to the registration centers from the service center.

12. The method set forth in claim 11, further comprising the step of: determining the predetermined segments in relation to a sponsor of a sporting event.

13. The method set forth in claim 11, further comprising the step of: disposing at least one of the registration centers in a bowling center.

14. The method set forth in claim 11, further comprising the step of: determining the predetermined segments in relation to a geographic area.

15. The method set forth in claim 11 further comprising the step of: selecting a computer for registering the individuals capable of receiving information inputted by the registrant and of displaying information received from the service center.

16. The method set forth in claim 15, further comprising the step of: providing a printer to print information at the selected computer.

17. The method set forth in claim 15, further comprising the step of: providing a bill validator to validate deposits of money made at the selected computer.

18. The method set forth in claim 15, further comprising the step of: providing a credit card acceptor to validating charges made at the selected computer.

19. The method set forth in claim 11, further comprising the step of: selecting a computer at the service center capable of receiving information transported from each registration center, determining the prize to be awarded in each predetermined segment and forwarding information about the prize to those registration centers located in the predetermined segment.

20. The method set forth in claim 19, further comprising the step of: selecting a back-up computer at the service center capable of receiving the information transported from each registration center, determining the prize to be awarded in each predetermined segment and forwarding information about the prize to those registration centers located in the predetermined segment.
